(19) United States
(12) Patent Application Publication
(10) Pub. No.: US 2006/0271443 A1
(43) Pub. Date: Nov. 30, 2006

(54) System and method for automatically generating and/or processing a photomask order using a script profiler

(76) Inventors: Daniel J. Cahalane, New Milford, CT (US); Charles E. Croke, Oakville, CT (US); Edward J. Suttile, Oxford, CT (US)

Correspondence Address: AMSTER, ROTHSTEIN & EBENSTEIN LLP, 90 PARK AVENUE, NEW YORK, NY, 10016, US

(21) Appl. No.: 11/139,741

(22) Filed: May 27, 2005

(51) Int. Cl. G06Q 30/00

(52) U.S. Cl. 705/26

(57) ABSTRACT

A method of generating a photomask order including generating a generic information user interface which prompts a user to input generic data about a customer placing the photomask order, and generating a custom order user interface which prompts the user to enter specific data necessary to complete the photomask order based on the generic data and/or previously entered specific data. A properties file is generated based on the specific data, and a command script file is accessed based on the properties file. A photomask order is generated using the command script file. In another embodiment, a system and method for processing a photomask order uses a generic information input interface and a specific information input interface to gather information regarding a potential photomask customer or a new photomask customer to generate setup files for a photomask order processing system. In another embodiment, a system and method for tracking photomask order uses a generic information input interface and a specific information input interface to gather information regarding a manufacturing environment of a photomask order to generate a message regarding the photomask manufacturing process.

### FIELD OF THE INVENTION

The present invention generally relates to a system and method for generating and/or processing a photomask order using a script profiler. More particularly, the present invention relates to a software-based application which can generate a photomask order which can be transferred to a photomask manufacturer's processing system to manufacture a photomask.

### BACKGROUND OF THE INVENTION

Photomasks are high precision plates containing microscopic images of electronic circuits. Photomasks are typically made from very flat pieces of quartz or glass with a layer of chrome on one side. Etched in the chrome is a portion of an electronic circuit design. This circuit design on the mask is also called “geometry.”

A typical photomask used in the production of semiconductor devices is formed from a “blank” or “undeveloped” photomask. As shown in FIG. 1, a typical blank photomask 10 is comprised of three or four layers. The first layer 11 is a layer of quartz or other substantially transparent material, commonly referred to as the substrate. The next layer is typically a layer of opaque material 12, such as Cr, which often includes a third layer of antireflective material 13, such as CrO. The antireflective layer may or may not be included in any given photomask. The top layer is typically a layer of photosensitive resist material 14. Other types of photomasks are also known and used including, but not limited to, phase shift masks, embedded attenuated phase shift masks (“EAPSM”) and alternating aperture phase shift masks (“AAPSM”).

The process of manufacturing a photomask involves many steps and can be time consuming. In this regard, to manufacturer a photomask, the desired pattern of opaque material 12 to be created on the photomask 10 is typically defined by an electronic data file loaded into an exposure system which typically scans an electron beam (E-beam) or laser beam in a raster or vector fashion across the blank photomask. One such example of a raster scan exposure system is described in U.S. Pat. No. 3,900,737 to Collier. Each unique exposure system has its own software and format for processing data to instruct the equipment in exposing the blank photomask. As the E-beam or laser beam is scanned across the blank photomask 10, the exposure system directs the E-beam or laser beam at addressable locations on the photomask as defined by the electronic data file. The areas of the photosensitive resist material that are exposed to the E-beam or laser beam become soluble while the unexposed portions remain insoluble. In order to determine where the E-beam or laser beam should expose the photoresist 14 on the blank photomask 10, and where it should not, appropriate instructions in the form of a jobdeck need to be provided to the processing equipment.

After the exposure system has scanned the desired image onto the photosensitive resist material 14, as shown in FIG. 2, the soluble photosensitive resist material is removed by means well known in the art, and the unexposed, insoluble photosensitive resist material 14′ remains adhered to the opaque material 13 and 12. Thus, the pattern to be formed on the photomask 10 is formed by the remaining photosensitive resist material 14′.

The pattern is then transferred from the remaining photoresist material 14′ to the photomask 10 via known etch processes to remove the antireflective material 13 and opaque materials 12 in regions which are not covered by the remaining photoresist 14′. There is a wide variety of etching processes known in the art, including dry etching as well as wet etching, and thus a wide variety of equipment is used to perform such etching. After etching is complete, the remaining photoresist material 14′ is stripped or removed and the photomask is completed, as shown in FIG. 3. In the completed photomask, the pattern as previously reflected by the remaining antireflective material 13′ and opaque materials 12′ are located in regions where the remaining photoresist 14′ remain after the soluble materials were removed in prior steps.

In order to determine if there are any unacceptable defects in a particular photomask, it is necessary to inspect the photomasks. A defect is any flaw affecting the geometry. This includes undesirable chrome areas (chrome spots, chrome extensions, chrome bridging between geometry) or unwanted clear areas (pin holes, clear extensions, clear breaks). A defect can cause the customer's circuit not to function. The customer will indicate in its defect specification the size of defects that will affect their process. All defects of that size and larger must be repaired, or if they cannot be repaired, the mask must be rejected and rewritten.

Typically, automated mask inspection systems, such as those manufactured by KLA-Tencor or Applied Materials, are used to detect defects. Such automated systems direct an illumination beam at the photomask and detect the intensity of the portion of the light beam transmitted through and reflected back from the photomask. The detected light intensity is then compared with expected light intensity, and any deviation is noted as a defect. The details of one system can be found in U.S. Pat. No. 5,563,702 assigned to KLA-Tencor.

After passing inspection, a completed photomask is cleaned of contaminants. Next, a pellicle may be applied to the completed photomask to protect its critical pattern region from airborne contamination. Subsequent through pellicle defect inspection may be performed. In some instances, the photomask may be cut either before or after a pellicle is applied.

After the manufacturing steps described above are completed, the completed photomask is sent to a customer for use to manufacture semiconductor and other products. In particular, photomasks are commonly used in the semiconductor industry to transfer micro-scale images defining a semiconductor circuit onto a silicon or gallium arsenide substrate or wafer. The process for transferring an image from a photomask to a silicon substrate or wafer is commonly referred to as lithography or microlithography. Typically, as shown in FIG. 4, the semiconductor manufacturing process comprises the steps of deposition, photolithography, and etching. During deposition, a layer of either electrically insulating or electrically conductive material (like a metal, polysilicon or oxide) is deposited on the surface of a silicon wafer. This material is then coated with a photosensitive resist. The photomask is then used much the same way a photographic negative is used to make a photograph. Photolithography involves projecting the image on the photomask onto the wafer. If the image on the photomask is projected several times side by side onto the wafer, this is known as stepping and the photomask is called a reticle.

As shown in FIG. 5, to create an image 21 on a semiconductor wafer 20, a photomask 10 is interposed between the semiconductor wafer 20, which includes a layer of photosensitive material, and an optical system 22. Energy generated by an energy source 23, commonly referred to as a Stepper, is inhibited from passing through the areas of the photomask 10 where the opaque material is present. Energy from the Stepper 23 passes through the transparent portions of the quartz substrate 11 not covered by the opaque material 12 and the antireflective material 13. The optical system 22 projects a scaled image 24 of the pattern of the opaque material 12 and 13 onto the semiconductor wafer 20 and causes a reaction in the photosensitive material on the semiconductor wafer. The solubility of the photosensitive material is changed in areas exposed to the energy. In the case of a positive photolithographic process, the exposed photosensitive material becomes soluble and can be removed. In the case of a negative photolithographic process, the exposed photosensitive material becomes insoluble and unexposed soluble photosensitive material is removed.

After the soluble photosensitive material is removed, the image or pattern formed in the insoluble photosensitive material is transferred to the substrate by a process well known in the art which is commonly referred to as etching. Once the pattern is etched onto the substrate material, the remaining resist is removed resulting in a finished product. A new layer of material and resist is then deposited on the wafer and the image on the next photomask is projected onto it. Again the wafer is developed and etched. This process is repeated until the circuit is complete.

To perform each of the manufacturing steps described above, a semiconductor manufacturer (e.g., customer) must first provide a photomask manufacturer with different types of data relating to the photomask to be manufactured. In this regard, a customer typically provides a photomask order which includes various types of information and data which are needed to manufacture and process the photomask, including, for example, data relating to the design of the photomask, materials to be used, delivery dates, billing information and other information needed to process the order and manufacture the photomask.

A long standing problem in the manufacture of photomasks is the amount of time it takes to manufacture a photomask from the time a photomask order is received from a customer. In this regard, the overall time it takes to process a photomask order and manufacture a photomask can be lengthy, and thus, the overall output of photomasks is not maximized. Part of this problem is attributable to the fact that many customers who order photomasks often place their orders in a variety of different formats which are often not compatible with the photomask manufacturer's computer system and/or manufacturing equipment. Accordingly, the photomask manufacturer is often required to reformat the order data and condition, convert, and/or supplement it to a different format which is compatible with its computer system and/or manufacturing equipment, which can take a great deal of time, and thus, delay the time it takes to manufacture a photomask.

In an attempt to address these problems, the photomask industry has developed various standard photomask order formats in which photomask orders should be placed. For example, the SEMI P-10 standard is one standard format used in the manufacture of photomasks. Additionally, a few semiconductor manufacturers have developed their own proprietary photomask order format in which photomask orders are to be placed, rather than adopting a standard format. These standard and proprietary photomask order formats were created so that photomask orders would be received from customers in a uniform format, thereby reducing the overall time it takes to manufacture a photomask.

Although the use of such standard and/or proprietary photomask order formats are useful in reducing the time it takes to manufacture photomasks, many semiconductor manufacturers have been reluctant to place their photomask orders in such standard and/or proprietary formats for a variety of reasons. For example, the SEMI P-10 standard order format is quite complicated and requires the customer placing the order to have a sophisticated working knowledge of the requirements associated with such standard. Since many semiconductor manufacturers do not manufacture photomasks, such manufacturers may not have the resources, time or ability to learn the intricacies of such standard format. Thus, semiconductor manufacturers often provide a photomask manufacturer with photomask order data in an unorganized and often incomplete manner. As a result, the photomask manufacturer is required to parse through this data and organize it in a useful format (e.g., in the SEMI P-10 format). Moreover, typically these standard and proprietary formats require a complete order to be submitted. This problem is particularly exasperated for small customers which do not have substantial resources to devote to developing an efficient photomask ordering system. Thus, there has been a long felt need in the field of photomask manufacture for a customer side system and method for automatically generating a photomask order in a standard and/or proprietary format which can be tailored to a specific customer with minimal effort on the customer part.

In the past, AlignRite Corporation (a predecessor organization to Photronics, Inc.), attempted to expedite the delivery of the electronic data through the use of an Internet based delivery system. However, although the AlignRite System was capable of rapid delivery of the photomask data from a customer to the computer system of the photomask manufacturer and was capable of validating the accuracy of this data in real time, this prior system did not provide for the automated generation of photomask order data in a single standard and/or proprietary format. In this regard, once the data was received from the customer, standard modifications to the data would also have to be entered manually by operators. Each time a manual change would have to be entered, the risk of human error increased and the overall length of the job would be extended. Further, the AlignRite System did not allow for customization of the order generation process depending upon the customer's whose data is being entered.

Since then, others have disclosed systems in which manufacturing and billing data are down-loaded over the Internet and verified on-line automatically. One such system is described in PCT Publication Number 02/03141, published on Jan. 10, 2002 to DuPont Photomask, Inc. which is also the subject of U.S. Pat. No. 6,622,295. More particularly, the DuPont PCT Publication discloses a system in which photomask order data is entered on-line by a customer and transmitted to a photomask manufacturer for processing. In this system, a customer is prompted to enter photomask order data. Such data is transmitted to a photomask manufacturer, which in turn performs a diagnostic evaluation of the data. If any data is incomplete or inaccurate, the system sends a message to the customer notifying him of such error. Thereafter, the user must correct the error. After the data has been validated by the manufacturer (and corrected when necessary), the manufacturer processes this data and puts it into a standard (or proprietary) format, such as the SEMI P-10 standard format.

Although useful for diagnostic purposes, the system of the DuPont PCT Publication is very cumbersome and provides a user with very little flexibility in formulating a photomask order depending upon the customer whose data is being entered. The DuPont system provides for no profiling of a customer's information based on the entry of generic information. Another disadvantage of DuPont's system is that a customer is required to reenter specific information regarding the order each time the customer uses the system and can not use the information entered in previous orders. Thus, using the DuPont system to generate a photomask order is time-consuming, particularly for repeat customers, and is not useful for so called “thin client” applications.

Similarly, Photronics, the assignee of the present application, in the past has developed its own photomask order generating system and method. Photronics' photomask order generating system, known as the MaskPilot® system, has demonstrated tremendous commercial success. This system is the subject of U.S. patent application Ser. Nos. 10/209,254, filed on Jul. 30, 2002, Ser. No. 10/877,011, filed on Jun. 25, 2004, and Ser. No. 10/974,449, filed on Oct. 27, 2004, all assigned to Photronics. The contents of each of these applications are incorporated by reference in their entirety herein. The MaskPilot® system includes a graphical user interface which prompts a user to enter photomask order information in the form of a template or order. Although effective in generating orders in various proprietary and/or standard photomask order formats, the MaskPilot® system does not perform profiling based on some generic information input by a user.

Upon being forwarded to the photomask manufacturer, the photomask order may be processed by a photomask processing system. Prior photomask order processing systems such as Cybermask® are known in the prior art. For example, U.S. Pat. No. 6,760,640 to Photronics, Inc. describes such a system and is hereby incorporated by reference as if it were set forth in its entirety herein. However, these photomask processing systems are not currently capable of automatic setup based on information provided by a user.

While the prior art is of interest, the known methods and apparatus of the prior art present several limitations which the present invention seeks to overcome.

In particular, it is an object of the present invention to provide a system and method for generating at least a portion of a photomask order which can be transferred to a photomask manufacturer's processing system to manufacture at least one photomask.

It is another object of the present invention to provide a photomask order generating system and method which are useful with “thin client” applications.

It is another object of the present invention to provide a photomask order generating system and method which can generate photomask orders using information from previous orders from the same customer.

It is another object of the present invention to provide an automatic photomask order generating system for reducing transcription errors associated with the manual entry of order data.

It is another object of the present invention to provide a photomask order generating system which can be used to increase the overall output of photomasks being manufactured.

It is another object of the present invention to provide a system and method for processing photomask orders which can be automatically setup based on information provided by a user;

It is another object of the present invention to provide a system and method for tracking photomask orders which allow a user to input information regarding manufacturing variables.

It is another object of the present invention to solve the shortcomings of the prior art.

Other objects will become apparent from the foregoing description.

### SUMMARY OF THE INVENTION

A method of generating a photomask order according to an exemplary embodiment of the invention includes generating a generic information user interface which prompts a user to input generic data about a customer placing the photomask order, and generating a custom order user interface which prompts the user to enter specific data necessary to complete the photomask order based on the generic data and/or specific data previously entered by the user. A properties file is generated based on the specific data, and a command script file is accessed based on the properties file. A photomask order is generated using the command script file.

In at least one embodiment, the generic data includes information identifying the customer.

In at least one embodiment, the generic data includes a login name and password.

In at least one embodiment, the specific data includes at least one of the following: billing information, shipping information, product type information, stepper equipment information, end product information, device name, mask titles, due dates, number of CDs, digitized data tone information, tooling specification.

In at least one embodiment, the specific data includes data which is pre-filled.

In at least one embodiment, the data which is pre-filled includes data which is editable by the user.

In at least one embodiment, the specific data which is prompted by the custom order user interface includes data which differs from that of a standard photomask order.

In at least one embodiment, the properties file is compatible for use with at least one of a variety of photomask order generating systems.

In at least one embodiment, the photomask order is generated in at least one of various proprietary and standard photomask order formats.

In at least one embodiment, the photomask order is a complete order in a standard photomask order format or a proprietary photomask order format.

In at least one embodiment, the photomask order is an incomplete order in a standard photomask order format or a proprietary photomask order format.

In at least one embodiment, the specific data entered by the user is validated.

In at least one embodiment, the user is prompted to enter correct data when the validating process reveals errors in the entry of specific data.

In at least one embodiment, the photomask order is submitted to a photomask manufacturer computer system for further processing.

In at least one embodiment, a message from the photomask manufacturer computer system is received confirming the status of the photomask order.

In at least one embodiment, a message from the photomask manufacturer computer system is received identifying at least one error in the photomask order.

In at least one embodiment, a message from the photomask manufacturer computer system is received confirming the photomask order has been correctly and completely submitted.

In at least one embodiment, the photomask order is submitted using one of the following: FTP, HTTP, SMTP and any application supported transfer protocol.

In at least one embodiment, at least one of the validity, feasibility and desirability of the photomask order is verified.

In at least one embodiment, the specific data is modified based on the results of the verifying step.

In at least one embodiment, the generic information user interface is a generic information input screen generated by a computer.

In at least one embodiment, the custom order user interface is a custom order entry screen generated by a computer.

In at least one embodiment, the generic information input screen and the custom order entry screen are generated at a local computer.

In at least one embodiment, the generic information input screen and the custom order entry screen are generated by a computer located at a remote location from a computer being used by the user.

A photomask order generating system according to an exemplary embodiment of the invention includes a generic data user interface generator that generates and formats a generic data user interface which prompts a user to input generic data regarding a customer placing a photomask order, and a custom order user interface generator that generates and formats a custom order user interface which prompts the user to enter specific data regarding the photomask order based on the generic data and/or other specific data previously entered by the user. A script generator accesses an appropriate set of scripts to run based on the specific data entered into the custom order input screen. A script engine runs the set of scripts accessed by the script generator to transform the specific data into components of the photomask order. A photomask order generator generates a complete or incomplete photomask order based on the components of the photomask order.

In at least one embodiment, a properties file stores the specific data in a format which is compatible with the photomask order generator.

In at least one embodiment, the generic data user interface is a web page.

In at least one embodiment, the generic data user interface includes a series of linked web pages.

In at least one embodiment, the custom order user interface is a web page.

In at least one embodiment, the custom order user interface includes a series of linked web pages.

In at least one embodiment, the scripting engine transforms the properties file into a photomask order object model.

In at least one embodiment, a verification system validates the specific data entered by the user.

In at least one embodiment, the verification system prompts the user to enter correct data when the validating process reveals errors in the entry of specific data.

In at least one embodiment, the verification system includes a photomask order transmitter that submits the photomask order to a photomask manufacturer computer system for further processing.

In at least one embodiment, the verification system further includes a messaging system that sends a message from the photomask manufacturer computer system to the user confirming the status of the photomask order.

In at least one embodiment, the messaging system sends a message from the photomask manufacturer computer system to the user identifying at least one error in the photomask order.

In at least one embodiment, the messaging system sends a message from the photomask manufacturer computer system to the user indicating that the photomask order has been completely and correctly submitted.

In at least one embodiment, the photomask order transmitter transmits the photomask order using one of the following: FTP, HTTP, SMTP and any application supported transfer protocol.

A system for generating photomask orders according to another exemplary embodiment of the invention includes a computer readable medium containing computer readable instructions executable on a processor to perform a method including: generating a generic information user interface which prompts a user to input generic data about a customer placing the photomask order; and generating a custom order user interface which prompts the user to enter specific data-necessary to complete the photomask order based on the generic data and/or other specific data previously entered by the user; generating a properties file based on the specific data; accessing a command script file used to generate a photomask order based on the properties file; and generating a photomask order using the command script file.

A method of processing a photomask order according to an exemplary embodiment of the invention includes generating a generic information user interface which prompts a user to input generic data about a customer placing a photomask order. A custom order user interface is generated which prompts the user to enter specific data necessary to process the photomask order based on the generic data and/or previously entered specific data. A properties file is generated based on the specific data. A setup file is generated for a photomask order processing system by accessing a command script file based on the properties file. The photomask order processing system is set up using the setup file, and the photomask order is processed using the photomask order processing system.

A method of tracking a photomask order according to an exemplary embodiment of the present invention includes generating a generic information user interface which prompts a user to input generic data about a manufacturing environment of a photomask order. A custom order user interface is generated which prompts the user to enter specific data regarding the manufacturing environment based on the generic data and/or previously entered specific data. A properties file is generated based on the specific data, and a message is generated by accessing a command script file based on the properties file.

These and other features of the invention are described in, or are apparent from, the following detailed description of various exemplary embodiments of this invention.

### BRIEF DESCRIPTION OF THE DRAWINGS

The above and related objects, features and advantages of the present invention will be more fully understood by reference to the following, detailed description of the preferred, albeit illustrative, embodiment of the present invention when taken in conjunction with the accompanying figures, wherein:

FIG. 1 represents a blank or undeveloped photomask of the prior art;

FIG. 2 represents the photomask of FIG. 1 after it has been partially processed;

FIG. 3 represents the photomask of FIGS. 1 and 2 after it has been fully processed;

FIG. 4 is a flowchart showing the method of using a processed photomask to make or process a semiconductor wafer;

FIG. 5 shows the process of making a semiconductor using a wafer stepper;

FIG. 6 is a block diagram of a photomask order generating system according to an exemplary embodiment of the invention;

FIG. 7 shows a decision tree useable with a photomask order generating system according to an exemplary embodiment of the invention;

FIG. 8 shows a flowchart showing a method of generating a photomask order in accordance with an embodiment of the present invention;

FIGS. 9-11 show various screens of an exemplary graphical user interface used with the invention to guide a user to enter generic photomask order information;

FIGS. 12 and 13 show various screens of an exemplary graphical user interface used with the invention to guide a user to enter specific photomask order information;

FIG. 14 is a flowchart illustrating a method of generating setup files for a photomask order processing system according to an exemplary embodiment of the invention;

FIG. 15 is a flowchart showing the requested information input to generate setup files for a photomask order processing system according to an exemplary embodiment of the invention;

FIG. 16-18 are screen shots of various webpages generated by a photomask order tracking system useable with the various exemplary embodiments of the present invention;

FIG. 19 shows a flowchart illustrating a method of generating an automatic output in response to climate control variable inout as part of a photomask tracking system according to an exemplary embodiment of the invention; and

FIG. 20 shows a node placed within a photomask tracking system according to an exemplary embodiment of the present invention.

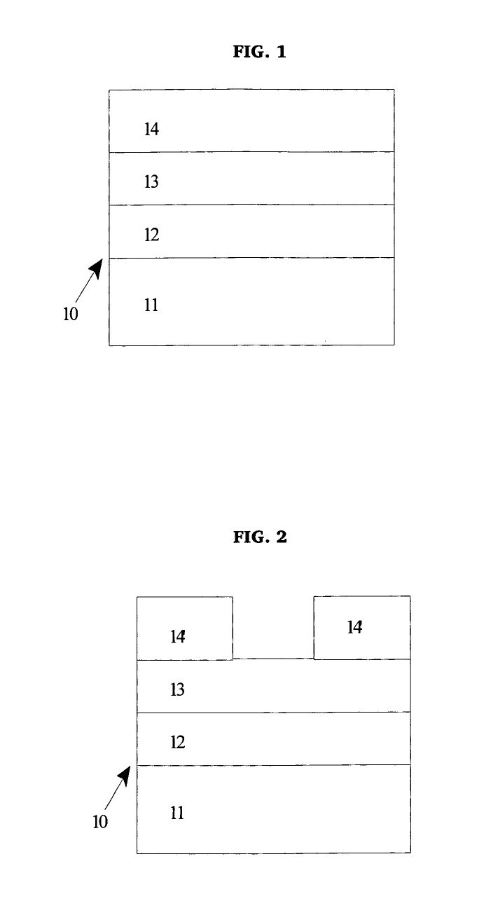

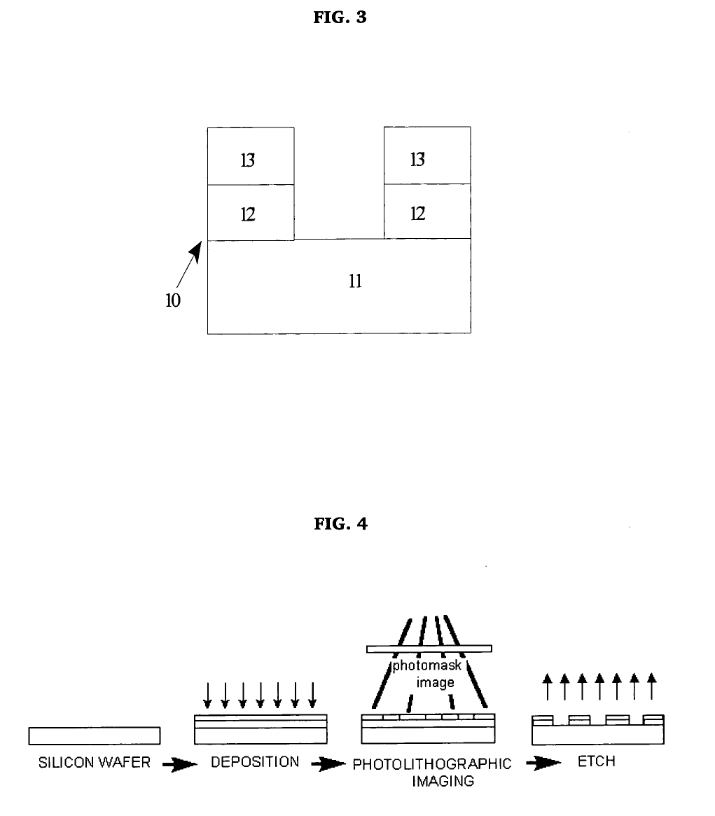

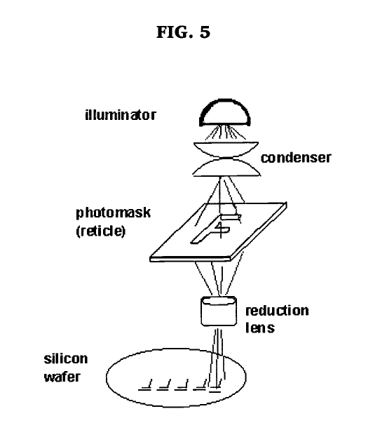

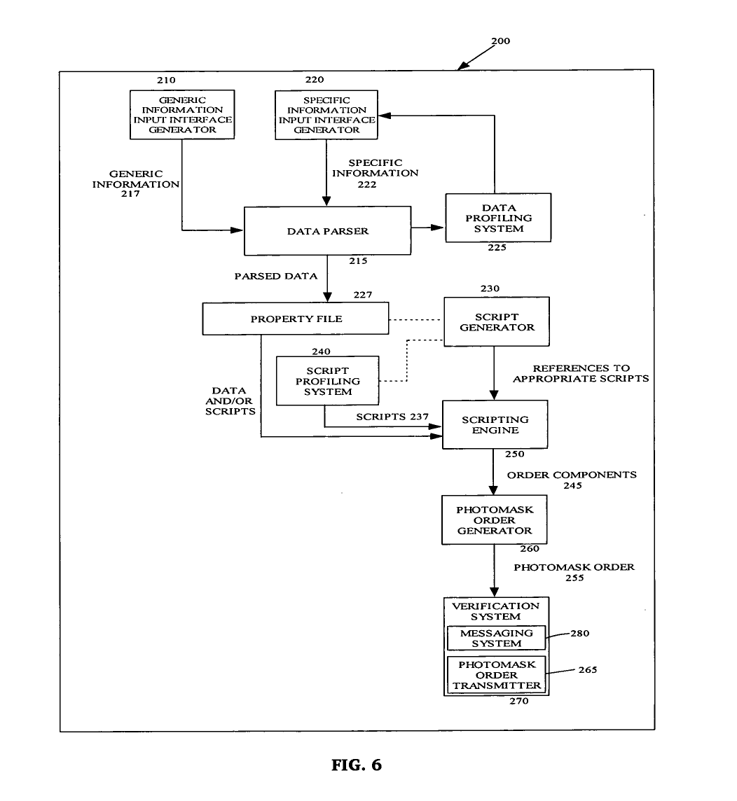

### DETAIL DESCRIPTION OF THE PREFERRED EMBODIMENT(S)

The present invention relates to a computerized rule-based system and method for collecting photomask-related information and automatically generating files containing instructions to perform one or more automated tasks by determining and running appropriate script files based on the information. An embodiment of the invention provides a system and method for automatically generating photomask orders using a script profiler, wherein a photomask customer desiring to place an order for a photomask may be guided through the process of entering an order in a complete and accurate manner in accordance with the requirements of the specified order format based on information provided by the customer. The photomask order generating system of the present invention is specifically designed to be particularly useful with so-called “thin client users”, although its principles can be applied to other types of users. The systems and methods of the present invention are designed to provide users the ability to generate photomask orders and/or provide the necessary information to a photomask manufacturer to generate a photomask order in a simple and efficient manner. Although various exemplary embodiments of the present invention are described herein as using Photronics' MaskPilot® scripting technique, such use is merely exemplary, and any other known or later-discovered system may be used that is able to transform specific information regarding a required photomask into a properly formatted photomask order. As will be described in further detail herein, the systems and methods of the present invention are also applicable to other photomask related systems, such as, for example, photomask order processing systems, such as Photronics' Cybermask® system and photomask order tracking systems, such as Photronics' MaskTrac® system.

FIG. 6 is a block diagram of a photomask order generating system 200 according to an exemplary embodiment of the invention. The photomask order generating system 200 may use software modules, firmware, or any other memory programming techniques, and in particular may be implemented by executing a program on a processor to perform the various system tasks. The photomask order generating system 200 includes a generic information input interface generator 210, a specific information input interface generator 220, a data parser 215, a data profiling system 225, a script generator 230, a script profiling system 240, a scripting engine 250 and a photomask order generator 260. The generic information input interface generator 210 generates and formats an input interface which prompts a user to input generic information 217 about a customer placing a photomask order. The specific information interface generator 220 generates and formats an input interface which prompts the user to enter specific information 222 regarding the photomask order based on the generic information 217. The input interfaces mentioned herein may include any suitable means for allowing a user to input information, such as, for example, a webpage or series of linked webpages, or a voice recognition system, to name a few. Depending on the specific information 222 provided, the specific information input interface generator 220 may generate and format additional input interfaces to prompt the user to enter additional specific information 222 regarding the photomask order. In this regard, the generating and formatting of an input interface for specific information 222 is preferably an iterative process that may use previously entered specific information 222 and which determines appropriate prompts for entry of additional specific information 222 using a rule-based decision tree. The decision tree may be fully or partially modifiable by a user so that the type and amount of information that the system 200 requires for input may be customizable.

The specific information 222 may be organized and stored in a script property file 227. The script generator 230 determines appropriate scripts 237 to run based on the specific information 222 by selecting from pre-defined scripts stored in the script profiling system 240. In other embodiments of the invention, the script generator 230 may also select scripts in the script property file 227 which were generated and stored in the script property file 227 during entry of the specific information 222. Once the appropriate scripts 237 are identified, the script generator 230 sends information to the scripting engine 250 regarding the appropriate scripts to be ran. The scripting engine 250 than runs the scripts 237 identified by the script generator 230 by accessing the scripts 237 in the script profiling system 240 and, if appropriate, scripts in the property file 227, as well as the specific information 222 stored in the property file 227. Running the script commands in the script file 237 through the scripting engine 250 results in the generation of order components 245 of a photomask order, preferably in the form of an object model, such as a MaskPilot® object model. The order components 245 or object model may then be used to generate a photomask order. The various elements of the photomask order generating system 200 are explained in more detail below.

The generic information input interface generator 210 may generate, for example, a generic information input screen that requests the user to enter generic information 217 relating to the photomask customer. The generic information input screen may request information such as login name and password, contact information, billing/shipping information, end-product type, and stepper type, to name a few. The generic information input screen may be, for example, a single web page or a series of linked pages which appear in sequence as the necessary information is input. The user need not manually enter all the requested generic information 217 with every use of the photomask order generating system 200, as some or all the generic information 217 may be automatically input based on the customer's previous orders once the customer is identified, such as by entering the customer's previously established login name and password.

Once the generic information 217 pertaining to the photomask customer is input, the data parser 215 transforms the generic information 217 into a format that can be read by the specific information input interface generator 220. Based on the parsed information, the specific information input r interface generator 220 determines what specific information 222 is needed to produce a valid photomask order. The specific information input interface generator 220 may determine that the required specific information includes, for example, billing information, shipping information, product type information, stepper equipment information, end product information, device name, mask titles, due dates, number of CD's; digitized data tone information, and/or tooling specification, to name a few. Once the required specific information is determined, the specific information interface generator 220 automatically generates and formats a custom order entry interface, such as a custom order entry screen, that requests the user to enter the specific information relating to the photomask customer's order. In this regard, the data profiling system 225 determines what additional specific information prompts, if any, are required as the user enters the specific information 222. In other words, the data profiling system 225 provides feedback to the specific information input interface generator 220 regarding the type of additional specific information required based on the specific information already entered by the user.

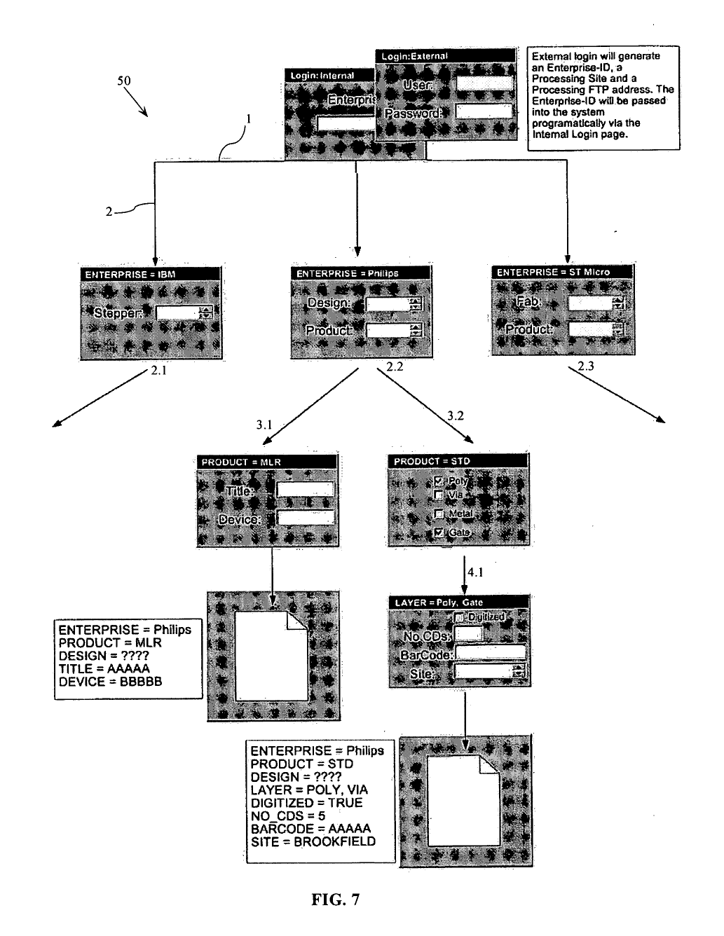

In this regard, the data profiling system 225 may use a rule-based decision tree to determine appropriate prompts for additional specific information based on specific information 222 previously entered by the user. FIG. 7 shows a portion of a decision tree 50 useable with the system 200 according to an exemplary embodiment of the invention. As discussed above, the user is prompted to enter some generic information 217, such as a username and password, at branch 1. Each username and password is setup to correspond to an enterprise ID, so that the system 200 is able to determine the user's enterprise (user's company) based on the entered username and password. In branch 2, additional information is requested depending on the enterprise. For example, in branch 2.1, since the enterprise is determined to be “A”, further information regarding “Stepper” is requested. Similarly, in branch 2.2, the enterprise is determined to be “B” and thus information regarding “Design” and “Product” is requested, and in branch 2.3, the enterprise is determined to be “C”, and thus information regarding “Fab” and “Product” is requested. In branch 3, further specific information 222 is required based on the data entry at branch 2. For instance, at branch 3.1, if the product is entered as “MLR” in branch 2.2, further information regarding “Title” and “Device” is requested, and at branch 3.2, if the product is entered as “STD”, further information regarding the layer is requested. Additional branches are provided as necessary and desired, such as, for example, branch 4.1, which requests further information regarding the layer.

The custom order screen may be, for example, a web page or a series of linked pages which appear in sequence as the necessary information is input. Alternatively, the specific information input interface generator 220 may be a wizard application guided to run with a photomask order generating system, such as MaskPilot®. In exemplary embodiments, the specific information input interface generator 220 may be a rule-based generator that prompts specific information and/or checks input values using a set of predetermined rules. The rules may be modifiable by the user and/or the photomask manufacturer. The specific information input interface generator 220 preferably has the ability to pre-fill some or all of the specific information 222 in the custom order entry screen based on the customer's previous orders. In this regard, some or all of the pre-filled entries may be modifiable and/or deleteable. In some instances, the order may be standard except for some minor deviations, in which case a custom order screen may be generated which requests only specific information relating to the potential deviations from the standard order. Thus, the user need not spend a large amount of time entering data.

Once specific information 222 is gathered by the specific information input interface generator 220, the specific information 222 may be stored in the properties file 227. The properties file 227 may be in the form of a database, for example, which may include the specific information 222 and/or script command lines which were generated during entry of the specific information 222. The properties file 227 stores the specific information 222 in a specific format such that the specific information 222 may be used by a photomask order generator to generate a photomask order. For example, in at least one embodiment of the invention, the specific information 222 is transformed into a MaskPilot® properties file, so that such information could be used to generate templates or orders by Photronics' MaskPilot® photomask order generating system. The properties file 227 may be in any format so as to be useable with any other known or later-discovered photomask order generating system. Elements of the properties file 227 may be stored in various steps as the specific information 222 is entered, where each storage step is able to define or execute an action, such as sending a message to a user or a set of instructions to a manufacturing device.

The script generator 230 determines which set of scripts to run using the specific information 222 as input. For example, in the case of MaskPilot®, the script generator 230 may determine the appropriate script file 237 which needs to be run to generate accurate and complete components of a photomask order. In this regard, the script generator 230 may also determine the appropriate script file 237 based on the desired proprietary and/or standard format of the photomask order. The script file 237 may be in the form of a plain text file that contains one or more script commands.

The scripting engine 250 runs the script files 237 selected by the script generator 230 to transform the data stored in the properties file 227 into components 245 of a photomask order. For example, the scripting engine 250 may generate a MaskPilot® object model, which may include components and subcomponents of a photomask order template.

The photomask order generator 260 generates a complete or incomplete photomask order 255 based on the components 245 generated by the scripting engine 250. For example, when the scripting engine 250 generates a MaskPilot® object model, a photomask order template may be used to generate a photomask order. In this regard, the photomask order generator 2650 is able to generate a photomask order in a variety of standard and/or proprietary formats. A partial photomask order generated by the photomask order generator 260 may be stored for later completion and/or modification by the user.

The photomask order generating system 200 may further include a verification system 270 that validates the photomask order 255. The verification system 260 may determine if any errors are present in the photomask order 255 and/or if the photomask order 255 is complete. In this regard, the verification system 270 may include a messaging system 280 that sends messages to the user indicating, for example, that the photomask order 255 had been generated, there are errors in the photomask order 255 or the photomask order 255 has been sent to a photomask manufacturer for processing. The messages may be in the form of e-mail, log files, text messages and/or database entries. In one embodiment, the messaging feature automatically generates a message sent to a distribution list of the names of people who will be involved in the ordering of the photomask. This distribution list can be established by any predetermined criteria. Once the message is generated, each person on the distribution list may be automatically notified that an order for a photomask has been generated. Such notifications may include e-mail, beepers, instant messaging, mobile telephones, etc. This automatic messaging process can be set up anywhere in the customer's network or even the manufacturer's network and be triggered by any step that the customer desires. This example should not be treated as limiting to the present invention and is merely illustrative of the type of messaging system that can be incorporated with the present invention.

The photomask order generating system 200 may also include a photomask order transmitter 265 that transmits the complete or incomplete photomask order 255 to a photomask manufacturer computer system to determine the validity, feasibility and/or desirability of the resulting photomask design, such as is disclosed in U.S. application Ser. No. 11/006,525 (attorney docket no. 67493/125), entitled “System and Method for Automatically Generating a Tooling Specification Using a Logical Operations Utility That Can Be Used To Generate A Photomask=Order”, filed Dec. 7, 2004 and assigned to Photronics, the contents of which are incorporated herein by reference in their entirety. For example, a partial photomask order including fracture instructions may be transmitted to the photomask manufacturer to be analyzed for validity, feasibility and/or desirability of the proposed design. Upon submission of the information, the photomask manufacturer may then also propose alternative designs which may be more feasible or desirable from the manufactures' perspective or otherwise. The results of the photomask manufacturer's analysis may then be transmitted to the customer for further consideration by the customer on whether to go forward with the order or modify the proposed order. For example, the custom order entry screen may appear on the customer's computer with modified entries, which can then be either accepted or rejected by the customer.

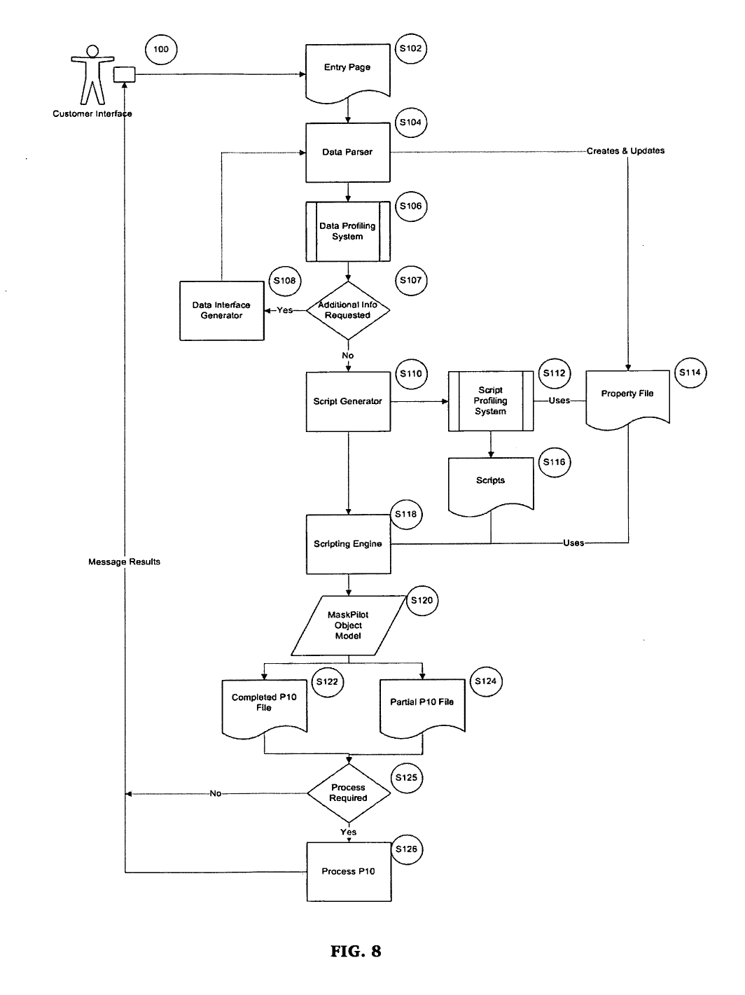

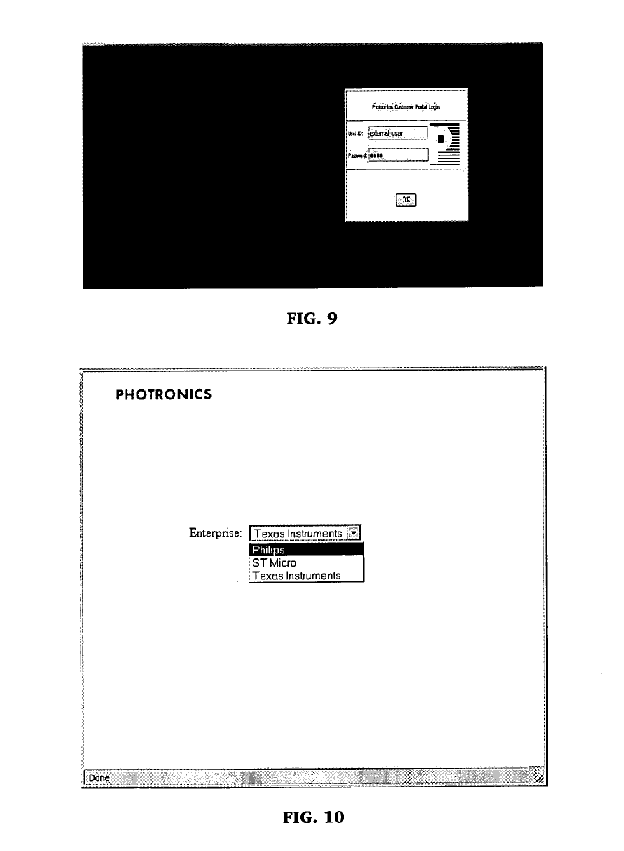

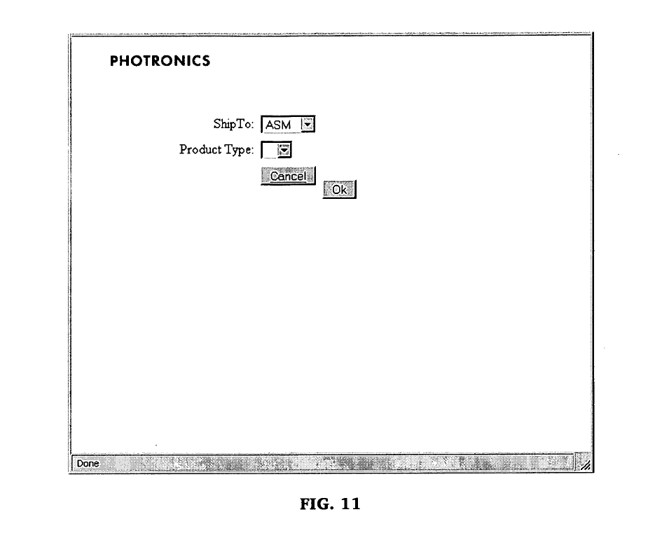

FIG. 8 is a flowchart illustrating a method of generating a photomask order according to an exemplary embodiment of the present invention. In step S102, a photomask customer or other user enters generic information 217 relating to the photomask customer into an entry page, or some other type of input interface. For example, the entry page may be accessed by entering a URL address into an Internet browser. In this regard, the user may access the entry page at a user interface 100, which may be, for example, a personal computer, BlackBerry®, or any other type of communication device. The customer may simply have to enter a username and password, after which additional generic information 217 will be automatically filled in to the generic information entry screen. For example, FIGS. 9-11 show various linked pages of a graphical user interface (GUI) useable with exemplary embodiments of the present invention. The first page 300 of the GUI requires entry of a User ID and password. Once a valid User ID and password is entered, a second page 310 may appear which requires entry of the customer's company name, as shown in FIG. 10. In this regard, the company name may be automatically filled in based on the customer's User ID and password, and such information may be modified by choosing the correct information from a pull-down menu. FIG. 11 shows a third page 320 of the GUI which requires entry of shipping information and product type. The generic information input screen may include any number and variation of pages which request input of generic information and/or display modifiable generic information relating to the photomask customer.

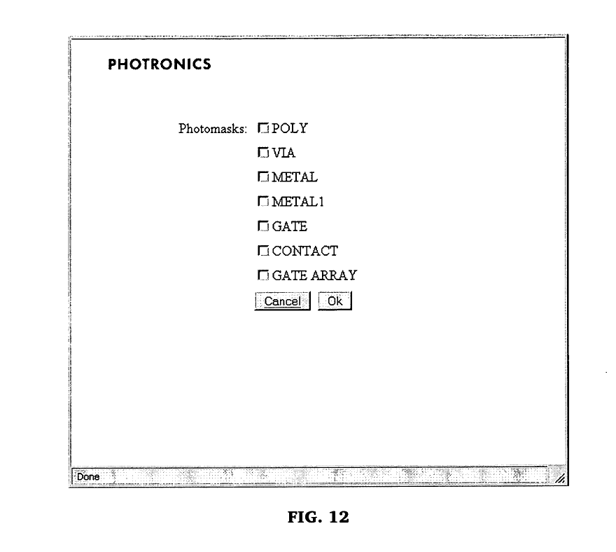

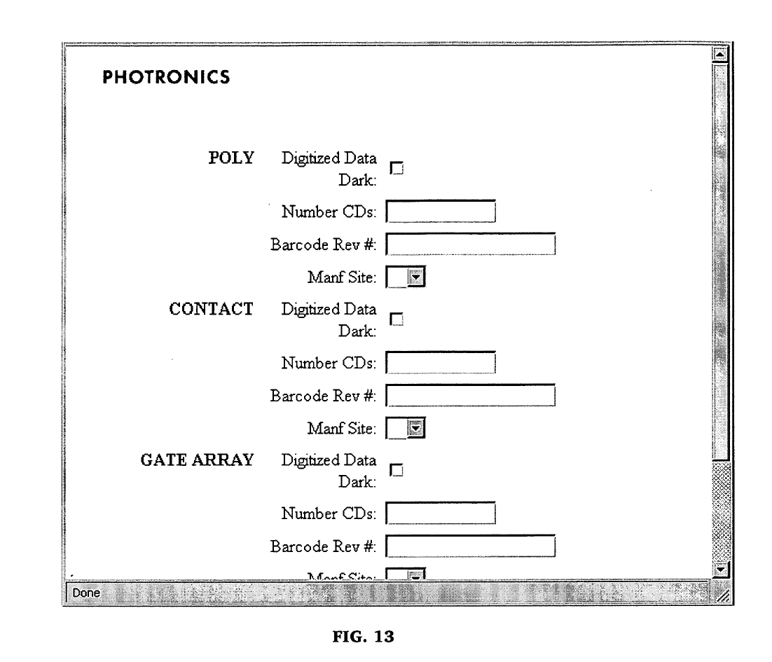

In step S104, the data parser 215 retrieves and formats the generic information 217 so that such information may be read by the data profiling system 225. In step S106, the data parser 215 sends the parsed data to the data profiling system 225. In step S107, the data profiling system 225 determines if additional information is required to generate a photomask order. In this regard, the profiling system 225 checks whether all the necessary information has been input and/or whether the input information is valid. If more information is needed and/or the entered information is invalid, the process continues to step S108, where a data interface generator generates an input screen, or some other type of input interface, at the user interface 100, which prompts the customer to input specific information 222 regarding the photomask order. In a preferred embodiment, the data interface generator may include both the previously described generic information input interface generator 210 and specific information input interface generator 220, although in other embodiments it should be appreciated that the data interface generator may be a single interface generator or a combination of any number of interface generators. Some or all of the specific information 222 relating to the photomask order may be automatically filled based on the generic information, in which case the customer may have the ability to modify and/or delete the information. FIGS. 12 and 13 show additional linked pages of the GUI useable with exemplary embodiments of the present invention. Page 330 of the custom order entry screen shown in FIG. 12 requires selection of the type of features that are to be formed using the completed photomask. Once the features are selected, a page such as that shown in FIG. 13 may appear which requires more specific information regarding the features, such as, for example, Digitized Data Dark (information relating to digitized data), Number CD's (information relating to critical dimension), Barcode Rev # (information to be barcoded) and Manf Site (information relating to the manufacturing site). Any or all of the information may be entered by manually filling in an empty entry box or by choosing from a pull-down menu. The custom order entry screen may include any number and variation of pages which request input of specific information and/or display modifiable specific information relating to the photomask order.

It should be appreciated that the process iterates through steps S104-S108 as many times as is needed to receive all of the necessary or desired information as set forth by the predefined decision tree. For example, at step S108, after entry of specific information, the custom order entry page may be redisplayed, regenerated and/or additional prompts may be added to existing pages to request missing information and/or correct invalid information. In this regard, as previously discussed, the data profiling system 225 determines what information is necessary using a rule-based decision tree structure. Thus, the process iterates through these steps to guide the user along the appropriate branches of the decision tree as the user enters the requested information.

In step S114, the specific information 222 entered in the custom order entry screen is stored in the property file 227, which may be in the form of a database. In this regard, information in the property file 227 may be updated and/or deleted based on the specific information entered into the custom order entry screen. In alternative embodiments of the invention, the property file 227 may also contain script command lines which were preprogrammed to automatically generate when the customer entered some specific data.

Once all the necessary specific information relating to the photomask order is accurately entered, the process continues to step S110, where the script generator 230 determines one or more appropriate script command lines that need to be ran to generate a photomask order based on the photomask order information input by the customer. In this regard, the script generator 230 accesses the script profiling system 240 at step S112, which is essentially a database of script command lines. In step S114, the script profiling system 240 may defer to the property file 227 to obtain necessary attributes and/or additional scripts which were generated during input of the photomask order information. In a preferred embodiment, the script generator 230 determines which of the one or more script command lines stored in the script profiling system 240 and/or the property file 227 should be run to obtain one or more script files in a desired format. As an example, in step S116, the script generator 230 may choose script command lines which will result in MaskPilot® scripts. However, the various exemplary embodiments of the present invention may be used to generate any type of script command lines.

In step S118, the scripting engine 250 assembles and runs the script command lines included in the one or more script files 237 identified by the script generator 230. In this regard, depending on the information provided by the script generator 230, the scripting engine 250 may retrieve script command lines from the script profiling system 240 as well as any scripts in the property file 227. Running the script command lines results in the generation of components 245 of a photomask order. For example, in the present embodiment, the scripting engine 250 generates a MaskPilot® object model, which may include components and subcomponents of a photomask order template. The components of the photomask order can then be used to generate a complete or incomplete photomask order in a variety of proprietary and/or standard photomask order formats, such as the standard SEMI P-10 format. For example, in step S122, the MaskPilot® object model is used to generate a complete P-10 file, and in step S124 the MaskPilot® object model is used to generate an incomplete P-10 file.

In step S125, it is determined whether the photomask order is to be processed. If so, in step S126 the photomask order may be sent to a photomask manufacturer for processing and to be used to manufacture a photomask. Messages may be forwarded to the customer at the user interface 100 indicating, for example, that the photomask order had been generated, there are errors in the photomask order or the photomask order has been sent to a photomask manufacturer for processing. The messages may be in the form of e-mail, instant messages, log files or database entries. In one embodiment, the messaging feature automatically generates a message sent to a distribution list of the names of people who will be involved in the ordering of the photomask. This distribution list can be established by any predetermined criteria. Once the message is generated, each person on the distribution list may be automatically notified that an order for a photomask has been generated. Such notifications may include e-mail, beepers, instant messaging, mobile telephones, to name a few. This automatic messaging process can be set up anywhere in the customer's network or even the manufacturer's network and be triggered by any step that the customer desires. This example should not be treated as limiting to the present invention and is merely illustrative of the type of messaging system that can be incorporated with the present invention.

The photomask order may be automatically forward to the photomask manufacturer, if no errors are present, or may be forwarded only after authorization from a user of the customer system. If errors are identified, the customer may be required to enter additional information so that there are no errors in the generated photomask order.

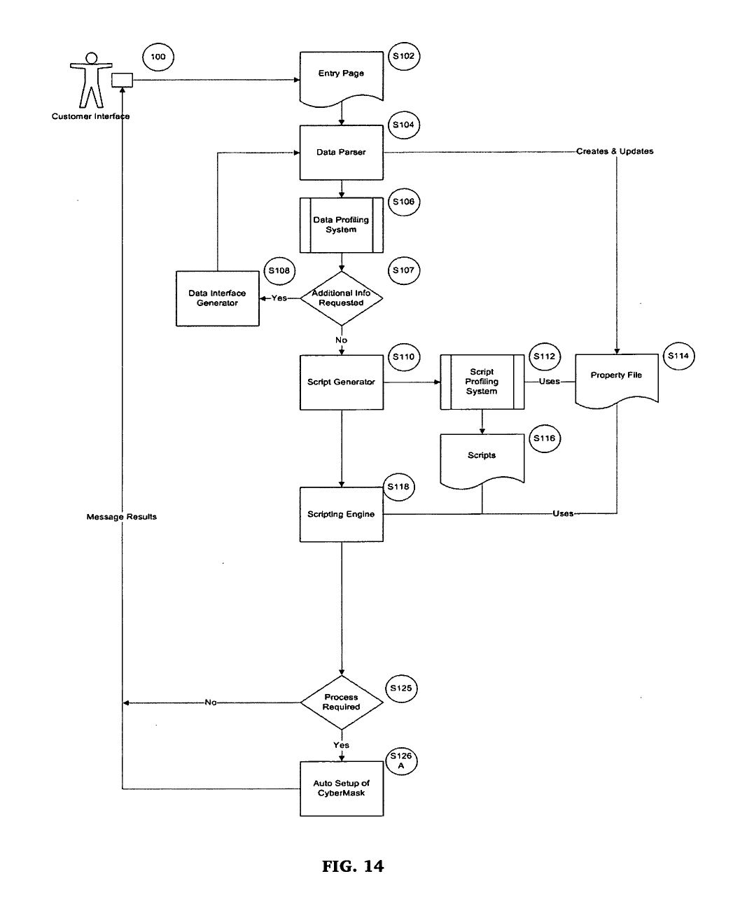

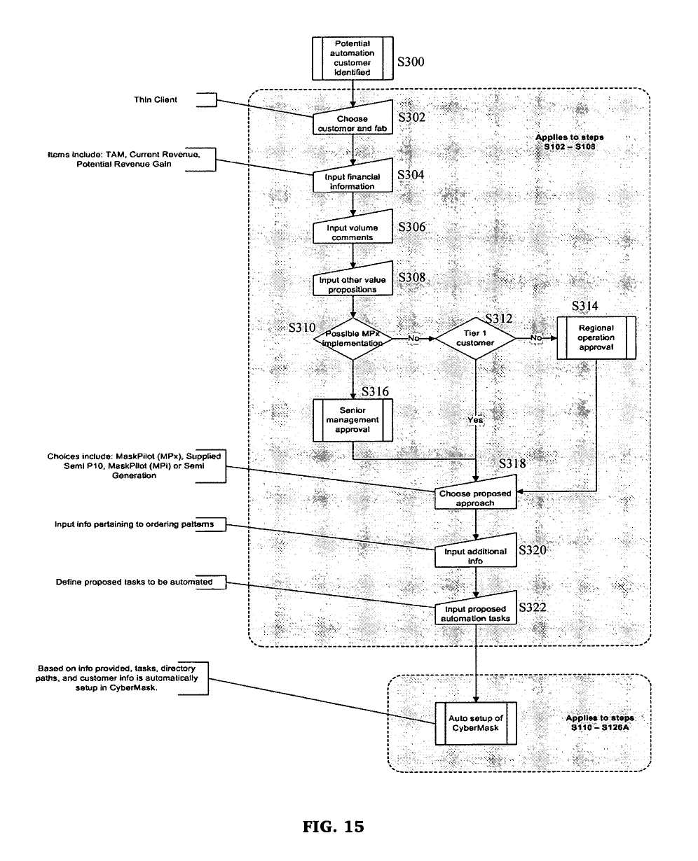

The previously described photomask order generating system 200 may be adapted to provide a photomask manufacturer with the ability to retrieve information relating to a potential or new customer and automatically generate Cybermask® setup files for the new or potential photomask customer. FIG. 14 is a flowchart illustrating a method of generating Cybermask® setup files according to an exemplary embodiment of the invention. Steps S102 through S108 are essentially the same as in the previous embodiment, except that the data profiling system 225 is setup to provide a decision tree that requests information regarding the potential or new customer and/or that allows for management to decide whether to approve the customer for further photomask order processing. As shown in FIG. 15, after the photomask manufacturer identifies a potential automation customer in step S300, the process continues on to provide the photomask manufacturer the ability to input information regarding the potential or new customer. For example, in step S302, the photomask manufacturer may be prompted to enter generic information relating to a potential photomask customer into a generic information entry screen, or some other type of input interface. In this step, the user may be prompted to enter the name of the potential photomask customer, such as by selecting from a pull-down list of known photomask customers, and the manufacturing facility (“fab”) of the potential customer. The photomask manufacturer may also be prompted to enter more specific information such as, for example, the potential customer's financial information (step S304), such as total available market (TAM), current revenue, and potential revenue gain, information relating to the volume of the potential customer (step S306), and other value propositions (step S308). Some or all of the specific information relating to the potential customer may be automatically filled based on the generic information, in which case the user may have the ability to modify and/or delete the information. At any point during entry of the specific information relating to the potential customer, an approval subroutine may be generated in which management of the photomask manufacturer has the opportunity to review the information relating to the potential customer and approve or disapprove of further processing of the potential customer's order. For example, at step S310, it is determined whether the customer is a good candidate for MaskPilot® implementation, or some other automated photomask order generating system. If so, the process continues to step S316, where senior management can be sent a print-out, e-mail or some other type of message that requests approval of the customer for MaskPilot® implementation. If the customer is not a good candidate for MaskPilot® implementation, the process may continue to step S312, where it is determined whether the customer is a “Tier 1 customer”, meaning that the customer is a valued customer based on the previously gathered information. If the customer is not a “Tier 1 customer”, the process continues to step S314, where regional operation approval is requested for processing of the customer's photomask order.

Further specific information required for entry, particularly after final approval by management and/or determination that the customer is a “Tier 1 customer”, may be selection of an appropriate means for entry of a photomask order received from the customer (step S318). For example, proposed approaches for entry of the photomask order may include the use of MaskPilot®, or by simply receiving a Semi P10 file. The custom order entry screen may also require information relating to ordering patterns (step S320) and may request the user to define proposed tasks to be automated (step S322).

In step S126A, Cybermask® setup files are automatically generated using the information stored in the property file 227 and the scripts ran by the scripting engine 250. Thus, such setup files do not need to be manually derived by the photmask manufacturer, thereby improving the speed and reducing the cost of the overall photomask manufacturing process. In particular, once all the necessary specific information relating to the photomask order is accurately entered, the process continues as in steps S110 through S125 to determine and run appropriate script command lines which results in the automatic generation of Cybermask® setup files. The Cybermask® system can then automatically process the customer's order, and send messages back to the user regarding the status of the order.

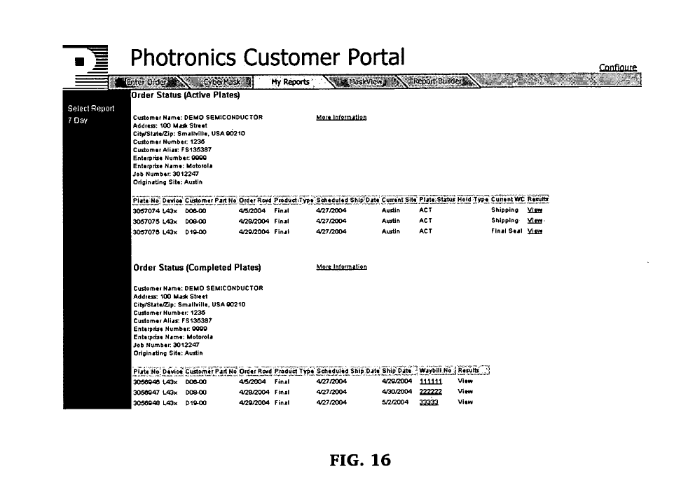

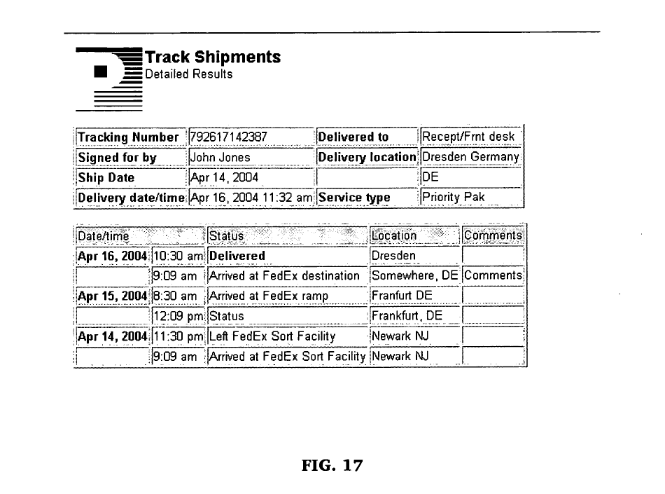

The system 200 may also be modified to function as a node implanted in a photomask order tracking system, such as Photronic's MaskTrac® system. The photomask order tracking system preferably provides a portal for customers or other users to monitor a photomask order from initial processing to final shipment. FIGS. 16-18 show various screen shots of webpages generated by a photomask order tracking system useable with the various exemplary embodiments of the present invention. It should be appreciated that the photomask order tracking system is not limited to implementation via webpages accessible over the Internet, and that such a system may be accessed via any other suitable user interface. FIG. 16 is a screen shot of a customer portal 400, which may be accessed by entry of a username and user ID. The customer portal 400 provides the status of photomask orders received from the customer, and in a preferred embodiment organizes the status results based on photomasks that are currently being processed (“active plates”) and those that are completed (“completed plates”). For active plates, the customer portal 400 may provide information such as, for example, the current site, the plate status, the hold type (if applicable) and the current status of the plate, to name a few. For completed plates, the customer portal may provide information such as, for example, the ship date and the waybill number, to name a few. FIG. 17 is a screen shot of a package tracking page 410, which shows the shipping status of a photomask order. The package tracking page 410 for a particular photomask order may be accessed by selecting the waybill number for the photomask order in the customer portal 400. The package tracking page 410 provides shipment information such as, for example, the tracking number of the shipment, the delivery location, the ship date, and the delivery date/time, to name a few.

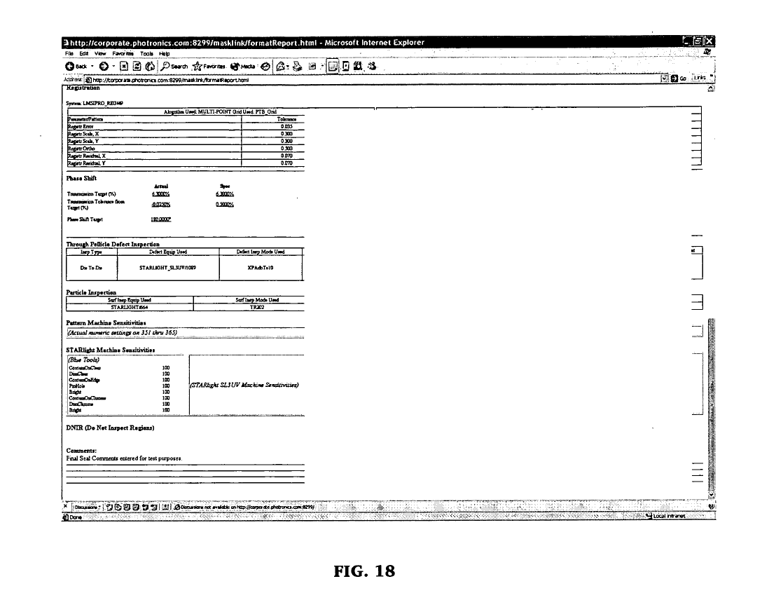

More detailed information regarding a photomask order can be viewed by selecting “view” under the “Results” category in the customer portal 400, which results in the display of a mask results page 420, a screen shot of which is shown in FIG. 18. The mask results page 420 provides detailed information regarding the completed or partially completed photomask, such as, for example, pattern tolerances, phase shift, defect and particle inspection methods used, and machine sensitivities, to name a few.

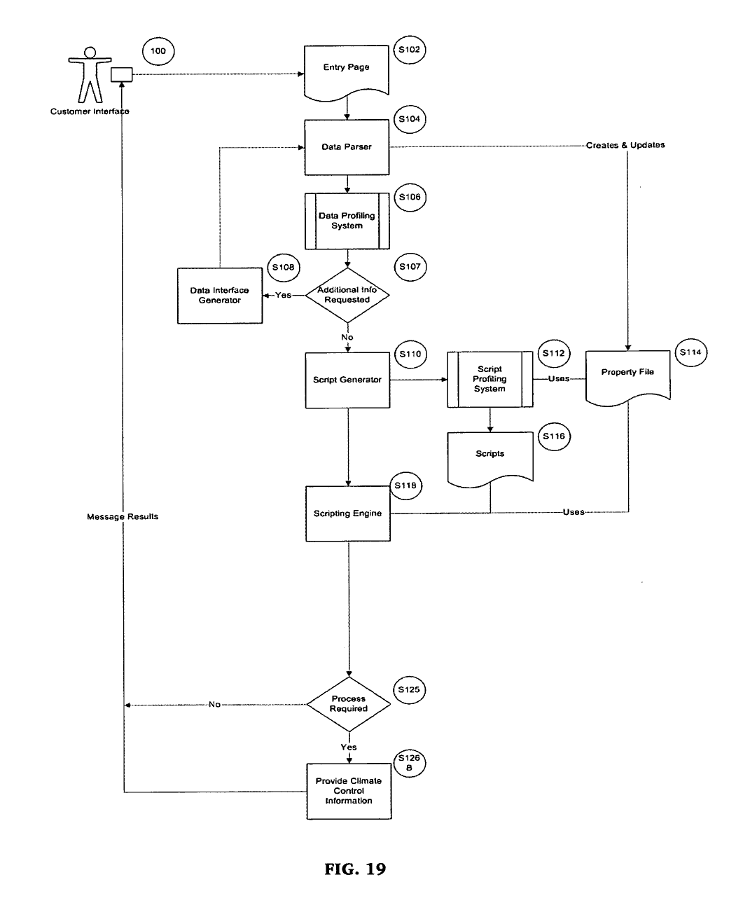

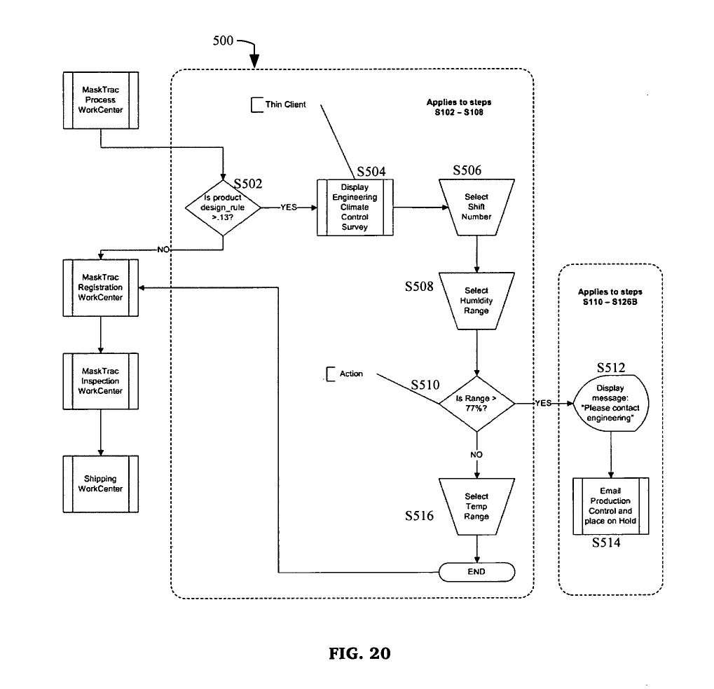

During processing of the photomask, it is often necessary to track manufacturing variables, such as, for example, environmental conditions which may have an effect on the finished photomask. Mask tracking systems, such as MaskTrac®, can be configured to allow for photomask manufacturers to monitor these variables by placing a node within the mask tracking system which requests the manufacturer to input certain information. Such a node may request information regarding one or more manufacturing variables, and then use the information to determine and run appropriate scripts which generate an e-mail or some other type of message and/or place the photomask manufacturing process on hold. For example, as shown in FIG. 20, a node 500 may be placed in the MaskTrac® system which allows a user to input climate control information. As shown in FIG. 19, the node 500 may allow the user to input the climate control information to a data interface by guiding the user through a decision tree, as previously described in regards to steps S102 through S108. Thus, the node 500 may first request whether the product design rule is greater than 0.13 (step S502). If so, the user may be presented with an engineering climate control survey (step S504), which may request the user to select a shift number (step S506), a humidity range (step S508) and a temperature range (step S516). The data profiling system 225 in the node 500 may be configured to generate a script file if any of the climate ranges are beyond acceptable limits. For example, if the humidity range is greater than 77% (step S510), the process may continue to step S126B, where a warning regarding the climate control information is generated. The warning may be in the form of, for example, a “Please contact engineering message” generated and displayed at the data entry screen (step S512), or an e-mail sent to production control (step S514). Step S510 in the present embodiment corresponds to step S107 in the previous embodiments, in that this step may “trigger” the script generator 230 to determine appropriate script files to be ran so as to perform the necessary function. In this embodiment, the script generator 230 refers to script files generated as a result of a humidity range being beyond acceptable limits, and the scripting engine 250 runs these scripts to generate a warning message and/or a command to hold the photomask order.

Now that the preferred embodiments of the present invention have been shown and described in detail, various modifications and improvements thereon will become readily apparent to those skilled in the art. Accordingly, the spirit and scope of the present invention is to be construed broadly and limited only by the appended claims and not by the foregoing specification.

What is claimed is:

1. A method of generating a photomask order comprising the steps of:
generating a generic information user interface which prompts a user to input generic data about a customer placing the photomask order;
generating a custom order user interface which prompts the user to enter specific data necessary to complete the photomask order based on the generic data and/or previously entered specific data;
generating a properties file based on the specific data;
accessing a command script file used to generate a photomask order based on the properties file; and
generating a photomask order using the command script file.

2. The method of claim 1, wherein the generic data comprises information identifying the customer.

3. The method of claim 2, wherein the generic data comprises a login name and password.

4. The method of claim 1, wherein the specific data comprises at least one of the following: billing information, shipping information, product type information, stepper equipment information, end product information, device name, mask titles, due dates, number of CDs, digitized data tone information, tooling specification.

5. The method of claim 1, wherein the specific data comprises data which is pre-filled.

6. The method of claim 5, wherein the data which is pre-filled comprises data which is editable by the user.

7. The method of claim 1, wherein the specific data which is prompted by the custom order user interface comprises data which differs from that of a standard photomask order.

8. The method of claim 1, wherein the properties file is compatible for use with at least one of a variety of photomask order generating systems.

9. The method of claim 1, wherein the photomask order is generated in at least one of various proprietary and standard photomask order formats.

10. The method of claim 1, wherein the photomask order is a complete order in a standard photomask order format or a proprietary photomask order format.

11. The method of claim 1, wherein the photomask order is an incomplete order in a standard photomask order format or a proprietary photomask order format.

12. The method of claim 1, further comprising the step of:
validating the specific data entered by the user.

13. The method of claim 12, further comprising the step of:
prompting the user to enter correct data when the validating process reveals errors in the entry of specific data.

14. The method of claim 1, further comprising the step of:
submitting the photomask order to a photomask manufacturer computer system for further processing.

15. The method of claim 14, further comprising the step of:
receiving a message from the photomask manufacturer computer confirming the status of the photomask order.

16. The method of claim 14, further comprising the step of:
receiving a message from the photomask manufacturer computer identifying at least one error in the photomask order.

17. The method of claim 14, further comprising the step of:
receiving a message from the photomask manufacturer computer confirming the photomask order has been correctly and completely submitted.

18. The method of claim 14, wherein the photomask order is submitted using one of the following: FTP, HTTP, SMTP and any application supported transfer protocol.

19. The method of claim 14, further comprising the step of:
verifying at least one of the validity, feasibility and desirability of the photomask order.

20. The method of claim 19, further comprising the step of:
modifying the specific data based on the results of the verifying step.

21. The method of claim 20, wherein the specific data is modified automatically.

22. The method of claim 20, wherein the specific data is modified manually by the user.

23. The method of claim 1, wherein the generic information user interface is a generic information input screen generated on a computer.

24. The method of claim 23, wherein the custom order user interface is a custom order entry screen generated on a computer.

25. The method of claim 24, wherein the generic information input screen and the custom order entry screen are generated at a local computer.

26. The method of claim 1, wherein the generic information input screen and the custom order entry screen are generated by a computer located at a remote location from a computer being used by the user.

27. The method of claim 24, wherein the generic information input screen and the custom order entry screen are generated by a computer located on an intranet with a computer being used by the user.

28. The method of claim 24, wherein the generic information input screen and the custom order entry screen are generated by a computer located on an extranet with a computer being used by the user.

29. A photomask order generating system comprising:
a generic data user interface generator that generates and formats a generic data user interface which prompts a user to input generic data regarding a customer placing a photomask order;
a custom order user interface that generates and formats a custom order user interface which prompts the user to enter specific data regarding the photomask order based on the generic data and/or previously entered specific data;
a script generator that accesses an appropriate set of scripts to run based on the specific data entered into the custom order input screen;
a script engine that runs the set of scripts determined by the script engine to transform the specific data into components of the photomask order; and
a photomask order generator that generates a complete or incomplete photomask order based on the components of the photomask order.

30. The system of claim 29, wherein the generic data comprises information identifying the customer.

31. The system of claim 31, wherein the generic data comprises a login name and password.

32. The system of claim 29, wherein the specific data comprises at least one of the following: billing information, shipping information, product type information, stepper equipment information, end product information, device name, mask titles, due dates, number of CDs, digitized data tone information, tooling specification.

33. The system of claim 29, wherein at least one of the data to be entered as specific data is pre-filled.

34. The system of claim 33, wherein the at least one of the data is editable by the user.

35. The system of claim 29, wherein the custom order entry page prompts the user to enter only data which differs from that of a standard photomask order.

36. The system of claim 29, further comprising a properties file that stores the specific data in a format which is compatible with the photomask order generator.

37. The system of claim 35, wherein the properties file is in the form of a database.

38. The system of claim 36, wherein the properties file is compatible for use with at least one of a variety of photomask order generators.

39. The system of claim 29, wherein the generic data user interface is a web page.

40. The system of claim 29, wherein the generic data user interface comprises a series of linked web pages.

41. The system of claim 29, wherein the custom order user interface is a web page.

42. The system of claim 29, wherein the custom order user interface comprises a series of linked web pages.

43. The system of claim 36, wherein the scripting engine transforms the properties file into a photomask order object model.

44. The system of claim 29, wherein the photomask order is generated in at least one of various proprietary and standard photomask order formats.

45. The system of claim 29, wherein the photomask order is a complete order in a standard photomask order format or a proprietary photomask order format.

46. The system of claim 29, wherein the photomask order is an incomplete order in a standard photomask order format or a proprietary photomask order format.

47. The system of claim 29, further comprising a verification system that validates the specific data entered by the user.

48. The system of claim 47, wherein the verification system prompts the user to enter correct data when the validating process reveals errors in the entry of specific data.

49. The system of claim 47, wherein the verification system comprises:
a photomask order transmitter that submits the photomask order to a photomask manufacturer computer system for further processing.

50. The system of claim 49, wherein the verification system further comprises:
a messaging system that sends a message from the photomask manufacturer computer system to the user confirming the status of the photomask order.

51. The system of claim 50, wherein the message is sent in at least one of the following formats: e-mail, beeper and mobile telephone.

52. The system of claim 50, wherein the messaging system sends a message from the photomask manufacturer computer system to the user identifying at least one error in the photomask order.

53. The system of claim 50, wherein the messaging system sends a message from the photomask manufacturer computer system to the user indicating that the photomask order has been completely and correctly submitted.

54. The system of claim 49, wherein the photomask order transmitter transmits the photomask order using one of the following: FTP, HTTP, SMTP and any application supported transfer protocol.

55. A system for generating photomask orders comprising a computer readable medium containing computer readable instructions executable on a processor to perform a method comprising the steps of:
generating a generic information user interface which prompts a user to input generic data about a customer placing the photomask order;
generating a custom order user interface which prompts the user to enter specific data necessary to complete the photomask order based on the generic data and/or previously entered specific data;
generating a properties file based on the specific data;
accessing a command script file used to generate a photomask order based on the properties file; and
generating a photomask order using the command script file.

56. The system of claim 55, wherein the generic data comprises information identifying the customer.

57. The system of claim 56, wherein the generic data comprises a login name and password.

58. The system of claim 55, wherein the specific data comprises at least one of the following: billing information, shipping information, product type information, stepper equipment information, end product information, device name, mask titles, due dates, number of CDs, digitized data tone information, tooling specification.

59. The system of claim 55, wherein the specific data comprises data which is pre-filled.

60. The system of claim 59, wherein the data which is pre-filled comprises data which is editable by the user.

61. The system of claim 55, wherein the specific data which is prompted by the custom order entry page comprises data which differs from that of a standard photomask order.

62. The system of claim 55, wherein the properties file is compatible for use with at least one of a variety of photomask order generating systems.

63. The system of claim 55, wherein the photomask order is generated in at least one of various proprietary and standard photomask order formats.

64. The system of claim 55, wherein the photomask order is a complete order in a standard photomask order format or a proprietary photomask order format.

65. The system of claim 55, wherein the photomask order is an incomplete order in a standard photomask order format or a proprietary photomask order format.

66. The system of claim 55, further comprising the step of:
validating the specific data entered by the user.

67. The system of claim 66, further comprising the step of:
prompting the user to enter correct data when the validating process reveals errors in the entry of specific data.

68. The system of claim 55, further comprising the step of:
submitting the photomask order to a photomask manufacturer computer system for further processing.

69. The system of claim 68, further comprising the step of:
receiving a message from the photomask manufacturer computer confirming the status of the photomask order.

70. The system of claim 68, further comprising the step of:
receiving a message from the photomask manufacturer computer identifying at least one error in the photomask order.

71. The system of claim 68, further comprising the step of:
receiving a message from the photomask manufacturer computer confirming the photomask order has been correctly and completely submitted.

72. The system of claim 68, wherein the photomask order is submitted using one of the following: FTP, HTTP, SMTP and any application supported transfer protocol.

73. The system of claim 68, further comprising the step of:
verifying at least one of the validity, feasibility and desirability of the photomask order.

74. The system of claim 73, further comprising the step of:
modifying the specific data based on the results of the verifying step.

75. The system of claim 74, wherein the specific data is modified automatically.

76. The system of claim 74, wherein the specific data is modified manually by the user.

77. The system of claim 55, wherein the generic information user interface and the custom order user interface are screens generated at a local computer.

78. The system of claim 55, wherein the generic information user interface and the custom order user interface are screens generated by a computer located at a remote location from a computer being used by the user.

79. The system of claim 55, wherein the generic information user interface and the custom order user interface are screens generated by a computer located on an intranet with a computer being used by the user.

80. The system of claim 55, wherein the generic information user interface and the custom order user interface are generated by a computer located on an extranet with a computer being used by the user.

81. A method of processing a photomask order comprising the steps of:
generating a generic information user interface which prompts a user to input generic data about a customer placing a photomask order;
generating a custom order user interface which prompts the user to enter specific data necessary to process the photomask order based on the generic data and/or previously entered specific data;
generating a properties file based on the specific data;
generating a setup file for a photomask order processing system by accessing a command script file based on the properties file;
setting up the photomask order processing system using the setup file; and
processing a photomask order using the photomask order processing system.

82. A method of tracking a photomask order comprising the steps of:
generating a generic information user interface which prompts a user to input generic data about a manufacturing environment of a photomask order;
generating a custom order user interface which prompts the user to enter specific data regarding the manufacturing environment based on the generic data and/or previously entered specific data;
generating a properties file based on the specific data; and
generating a message by accessing a command script file based on the properties file.
